(19) United States
(12) Patent Application Publication
(10) Pub. No.: US 2008/0059877 A1
(43) Pub. Date: Mar. 6, 2008

(54) Method for automatically adjusting the components of a screen region to maintain layout integrity in multiple languages

(76) Inventors: David Brookler, Los Angeles, CA (US); Paul Weinberg, (US)

Correspondence Address: SAP_DLG, 7910 IVANHOE AVE., # 325, LA JOLLA, CA, 92037, US

(21) Appl. No.: 11/512,866

(22) Filed: Aug. 29, 2006

(51) Int. Cl. G06F 17/00; G06F 3/048

(52) U.S. Cl. 715/264; 715/243; 715/246; 715/764

(57) ABSTRACT

A method for automatically adjusting the components of a screen region such as a dialog box to maintain layout integrity independent of displayed language. For example, if two components such as a label and text field are treated as a group and given a desired width, then if the displayed language is changed from English to German and the label becomes longer, then embodiments of the invention make the text field smaller so that the group itself does not change. Allows for grouping components and associating row and column settings with components in order to rapidly create dialogs that resize automatically based on the language of the text elements displayed within them. Embodiments are also configured to make the programming task easier by limiting the number of parameters that are required in order to specify how components are positioned and sized in a dialog user interface component.

### BACKGROUND OF THE INVENTION

1. Field of the Invention

Embodiments of the invention described herein pertain to the field of graphical user interfaces. More particularly, but not by way of limitation, one or more embodiments of the invention are directed to a method for enabling a computer to automatically adjust the components of a screen region such as a dialog box to maintain layout integrity in multiple languages.

2. Description of the Related Art

Dialog boxes are special windows that are used by computer programs or by the operating system to display information to the user, or to get a response if needed. They are so-called because they form a dialog between the computer and the user—either informing the user of something, or requesting input from the user, or both. Dialog boxes used in existing graphical user interface are generally created with hardcoded, fixed width component sizes. This creates a problem for components within a dialog box that may need to present the same basic information in two or more languages due to the fact that words or phrases in two different languages are in general different lengths. If attempting to merely change labels into another language for a given sized dialog for example, some of the text labels may overlap or be truncated. This is because programmers generally design dialog boxes with only a single language in mind. Hence when the interface is adapted for use in another language the interface must typically be redesigned to accommodate the new language.

Using available integrated development environments and user interface libraries provides little help since each generated dialog is generally hardcoded for a given language. For example, using Microsoft Foundation Classes (MFC) in a programmatic methodology requires that separate dialogs boxes be created for each language, each with specific numerical values for the width and height and position of each component. Creating a separate dialog box for each language is unacceptable for many reasons such as when the number of languages is high, or when maintenance of the software is an issue as is the case for large programs. Maintenance related problems arise when a programmer alters the label on a dialog box in one language, but does not do so for the same dialog box in a different language. This causes problems for customer support and data integrity within the system since the same graphical component in two different languages may yield inputs that are incoherent with respect to the different languages the dialog may be presented in. This further causes data integrity problems in back end database systems since input for the same dialog box in different languages may yield entirely different inputs.

Graphical user interface components in some languages attempt to provide a grid-based layout that allows cooperation of the displayed components to yield a coherent dialog. An example of this type of layout is the GridBagLayout within the java.awt package within Java™. Each component is presented with anchor values that are absolute or relative based on GridBagConstraints. The GridBagConstraints determine where a given component should be located on a grid. The GridBagLayout uses the grid and GridBagConstraints related to each component to position each component on the grid using minimum and preferred sizes in order to determine how much space to allocate for each component. There are many problems with GridBagLayout including the complexity of the class and the learning curve associated with using the class. The GridBagConstraints class uses 33 different fields to define layout, making it complex to use. This class is an example of a class that attempts to solve all problems for all situations. The learning curve for using both the GridBagLayout and associated GridBagConstraints classes is very high, which is why many Java programmers tend not use this class. In addition, the class lacks an inherent ability to dynamically switch displayed languages while maintaining a layout that is visually pleasing in multiple languages. For example there are no defined methods such as a key stroke or mouse click that can be used to switch the display of one language to the other while maintaining the defined layout.

To overcome the problems and limitations described above there is a need for an improved method for automatically adjusting the components of a dialog box to maintain layout integrity in multiple languages.

### BRIEF SUMMARY OF THE INVENTION

One or more embodiments of the invention are directed to a method for automatically adjusting the components of a dialog box to maintain layout integrity regardless of the displayed language. For example, if two components such as a label and text field are treated as a group and given a desired width, then if the displayed language is changed from English to German and the label becomes longer, embodiments of the invention may make the text field smaller so that the group itself does not change. One or more embodiments of the invention group components and associate layout information such as row and column settings with each components or group of components in order to rapidly create dialogs that resize automatically based on the language of the text elements displayed within them. Embodiments are also configured to make the programming task easier by limiting the number of parameters required to specify how components are positioned and sized in a dialog box user interface component. Readers should note that although the invention is described using dialog boxes as an example the methods described herein are applicable to any window or screen region of a graphical user interface that is presents multi-lingual data. As such the invention is not to be limited solely to a method for resizing dialog box components but rather is applicable to any window, component or widget within a screen region that presents information in two or more languages.

In one or more instances the method for automatically adjusting the components of a screen region such as a dialog box to maintain layout integrity in multiple languages makes use of the following generalized methodology. The individual components to be presented in the screen region are queried as to their length for a given font. If the components are determined to have an association with other components as a result of a defined relationship referred to as a grouping or association, the longest of the components, (or sub-components recursively defined in child groupings) is utilized in sizing the width of the grouping. Hence when multiple components are defined to have a relationship sizing is dictated by viewing the components in combination. When the screen region (e.g., dialog box) is switched to another language, the component lengths are calculated for the selected language and utilized in resizing the width of the various components and/or grouping of components within the screen region. To avoid flicker, one or more embodiments disable automatic refresh for the windowing system while the screen region is dragged to a new size. The components and background are redrawn programmatically once instead of many times per second. This eliminates flicker on the screen. To accomplish resizing of screen regions such as dialogs, one or more embodiments of the invention save the initial configuration parameters for use when switching languages or when the screen region is resized by a user. During a callback involved with switching the language displayed in the screen region or when a screen region is resized by a user, the saved configuration parameters are utilized in resizing the screen region.

For some component types such as a text area, a calculation of the text width in the text area yields a relatively large number that defines how long the text would be if displayed on one line. To avoid this type of sizing when calculating the widths of the various components, the text area is given a maximum displayable width and height size that allows for wrapping of the text. Alternatively, the text area uses a setting that signifies the number of rows the text is to be displayed in. Text wrapping is accomplished via white space breaks before the maximum displayable width, or makes use of hyphenation libraries that automatically hyphenate words using language dependent rules or tables. Alternatively, the user can choose to manually specify line breaks.

Embodiments of the invention are implemented by defining the row and column to be used for a component or group of recursively nested components. The widths from the components are calculated based on the grouping the components reside within or are set as minimum sizes by the user. For example in a grouping having a text field spanning two columns wherein each column has a set of radio buttons in each column with labels is sized as follows. The innermost components or deepest hierarchically nested components are queried for their size based on the display language in use. For each column in this example, each label for each radio button is queried to determine its width for the language to display the component in. The height of each component generally does not change when switching languages since it is based on the font in use. When the component with the largest width is found, the column is assigned a calculated size that makes use of the width of the radio button, the longest text label and default spacing around each component. The spacing around each component may likewise be set by the operator to yield a minimum acceptable space for example. Once each column has been sized, the text field spanning the two columns is then sized. If the spanning text field also is part of a grouping, for example if it also makes use of a label, then the larger of the sum of the two radio button columns or the width of the spanning group is taken as the width of the dialog. If the language is changed or the screen region is resized, the calculations are performed again.

In the case of images, the images may also be specified to exist in a given column within a grouping and may be set to automatically scale up to fit the allotted row and column or alternatively may be set to remain a fixed size.

### BRIEF DESCRIPTION OF THE DRAWINGS

The above and other aspects, features and advantages of the invention will be more apparent from the following more particular description thereof, presented in conjunction with the following drawings wherein:

FIG. 1A shows a group of components, namely a text label and a text field displayed in a first language.

FIG. 1B shows the same group of components shown in FIG. 1A displayed in a second language and wherein the label in the second language is larger than the label in the first language shown in FIG. 1A and wherein the text field shown in FIG. 1B is narrower than the text field shown in FIG. 1A.

FIG. 2 shows a group having radio buttons and text labels wherein the grouping is used to maintain a width for a column that displays the grouping of components.

FIG. 3 shows elements of the group shown in FIG. 2 along with width arrows for the components in the grouping.

FIG. 4 shows three groupings, one group spanning the width of two other groups.

FIG. 5 shows the same components shown in FIG. 4 with different sized columns.

FIG. 6 shows a popup menu used to switch displayed languages and the resulting dialog when displayed in a second language.

FIG. 7 shows a mouse-drag used to alter the size of the dialog for a given display language.

FIG. 8 shows a flowchart for an embodiment of the method for adjusting the components of a dialog box.

FIG. 9 shows a flowchart for an embodiment of the method for adjusting the components of a dialog box using a new language setting.

FIG. 10 shows a flowchart for an embodiment of the method for adjusting the components of a dialog box using a mouse-drag for a given language setting.

### DETAILED DESCRIPTION

A method for automatically adjusting the components of a dialog box to maintain layout integrity in multiple languages will now be described. In the following exemplary description numerous specific details are set forth in order to provide a more thorough understanding of embodiments of the invention. It will be apparent, however, to an artisan of ordinary skill that the invention may be practiced without incorporating all aspects of the specific details described herein. In other instances specific features or functionality well known to those of ordinary skill in the art have not been described in detail so as not to obscure the invention. Readers should note that although examples of the invention are set forth herein, the claims, and the full scope of any equivalents, are what define the metes and bounds of the invention.

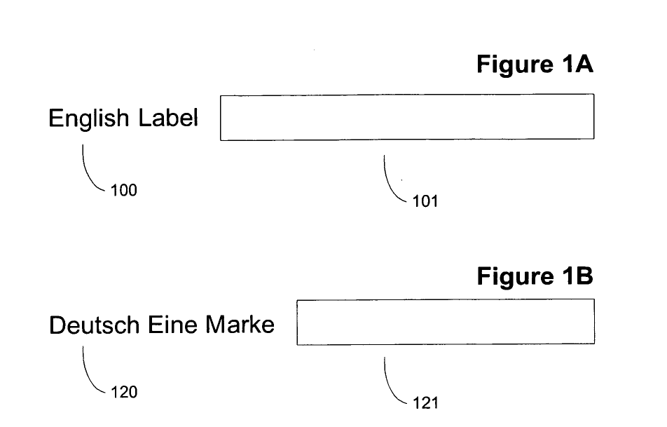

One or more embodiments of the invention enable a method for automatically adjusting the components of a screen region such as a dialog box to maintain layout integrity regardless of what language is displayed. For example, if two components such as a label and text field are treated as a group and given a desired width, then if the displayed language is changed from English to German and the label becomes longer, embodiments of the invention may make the text field smaller so that the group itself does not change. FIG. 1A shows a group of components, text label 100 and a text field 101 displayed in a first language, here English. FIG. 1B shows the same group of components shown in FIG. 1A displayed in a second language, here German and wherein text label 120 in the second language is larger than text label 100 in the first language shown in FIG. 1A and wherein text field 121 shown in FIG. 1B is narrower than text field 101 shown in FIG. 1A. This example is further illustrated in the following paragraphs and figures.

One or more embodiments of the invention allow for grouping components and associating row and column settings with components in order to rapidly create screen regions that resize automatically based on the language of the text elements displayed within the screen region. The example set forth herein is described using dialog boxes. Readers should note however that the solutions described herein are also applicable to other types of screen regions contained within a graphical user interface and that the invention is not limited to use in dialog boxes only. Embodiments of the invention are also configured to make the task of programming easier by limiting the number of parameters required in order to specify how components are positioned and sized in a screen region such as a dialog user interface component.

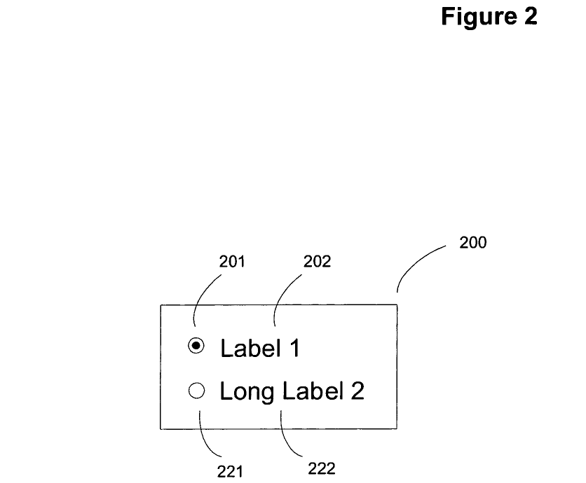

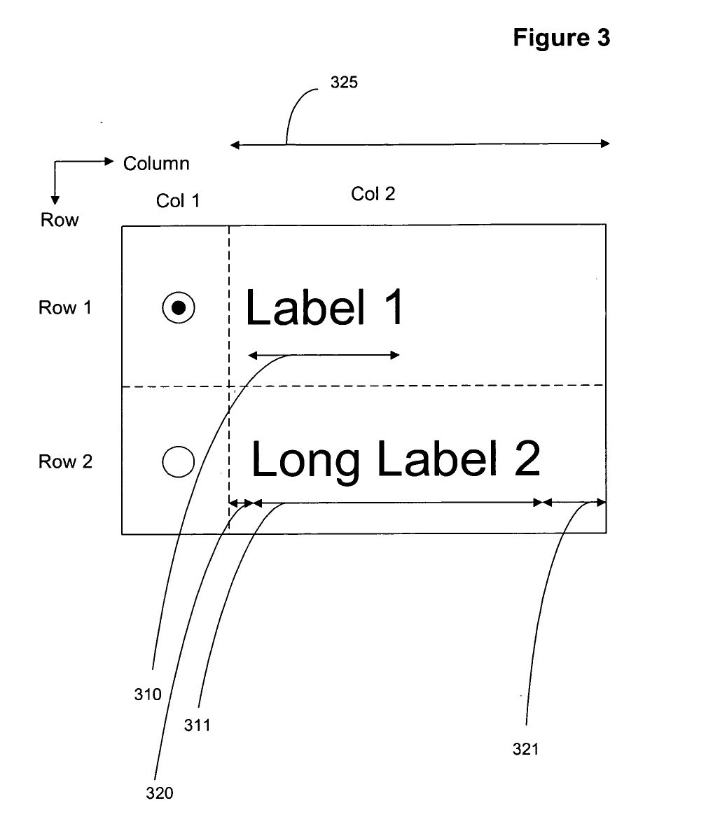

FIG. 2 shows grouping 200 having radio buttons 201 and 221 and text labels 202 and 222 wherein grouping 200 is used to maintain a width for a column that displays the components within the grouping. FIG. 3 shows elements of the grouping shown in FIG. 2 along with width arrows for the components in the group. Specifically, each component within a group is associated with a given row and column. A specific entry at a given row and column is known as a cell or cell designation. The cells identify where each component within the screen region is permitted as determined by the layout. Hence, cell at row 1, column 1 contains a radio button (here shown as selected), while row 2, column 2 contains text label 222 as per FIGS. 2 and 3. With regards to FIG. 3, column 2 width 325 is calculated by determining the wider of text labels 202 and 222. Text label width 310 and text label width 311 are shown graphically in FIG. 3 and are mathematically differenced to determine the larger of the two. Alternatively a function call in a math library, e.g., y=MAX(a,b) is utilized to determine the wider of the components for a given column. This function call is performed iteratively when more than two components exist in column for example. Half space 320 and full space 321 is added in one or more embodiments of the invention in order to provide internal and outer spacing around components respectively. For example, half space 320 exists away from an outer boundary and as such would adjoin the half space associated with the right side of radio button 221 in order to form a full space when residing next to half space 320. Likewise, vertical spacing may be accomplished in the same manner, however heights of components can but generally do not change when selecting a different display language. Regardless of the method utilized in determining that label 222 is wider than label 202 for a given language setting, column 2 width 325 is calculated based on longest text width 311, and optionally any default or desired spacing accepted by the system via user input.

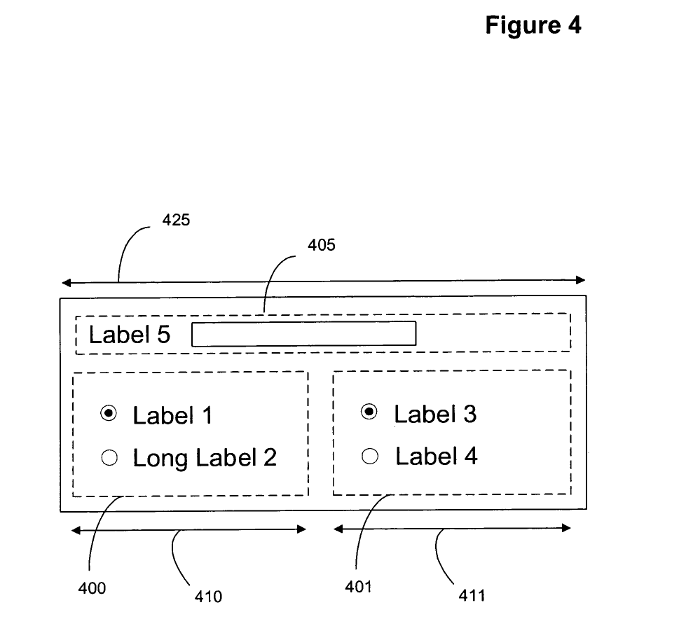

FIG. 4 shows three groupings, one group 405 spanning the width of two other groupings 400 and 401 respectively. In this example, grouping 405 contains a text label and a text field. The grouping has a setting of “SPAN” associated with it and a row setting of 1 and column setting of 1 since this group lies in the first row and first column of the dialog. The SPAN setting also have a row and column setting, here row 1 and column 2 to signify that the group spans two columns in row 1. The three groupings are shown with dashed lines since the lines may or may not be presented when the components are displayed. In this figure, the setting “SAME_WIDTH” is applied to component group 400 and 401 and is utilized to signify that the width of each component group is to be the largest of the two groups. In this example, “Long Label 2” in group 400 determines the width of not only group 400 but also group 401. Hence group width 410 and group width 411 are set to the same value that depends on the displayed language, here English.

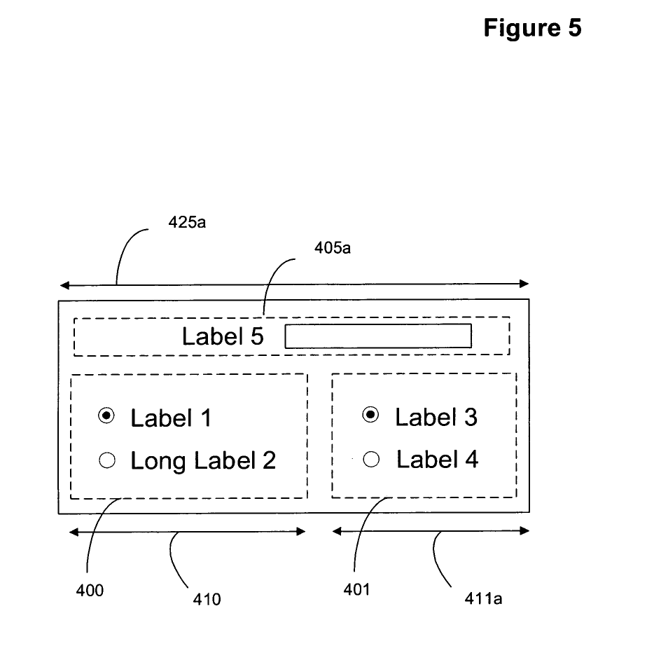

FIG. 5 shows the same components shown in FIG. 4 with different sized columns. In this figure, group 400 and group 401 are not associated with “SAME_WIDTH” and so each grouping and the components contained within them are used to determine group width 410 and 411a. In this example, since the text labels associated with group 401 are narrower than the text labels associated with group 400, column 2, e.g., group 401 is narrower than group 400. The overall width of the dialog 425a and group 405a are likewise narrower since they depend on the width 411a of group 401.

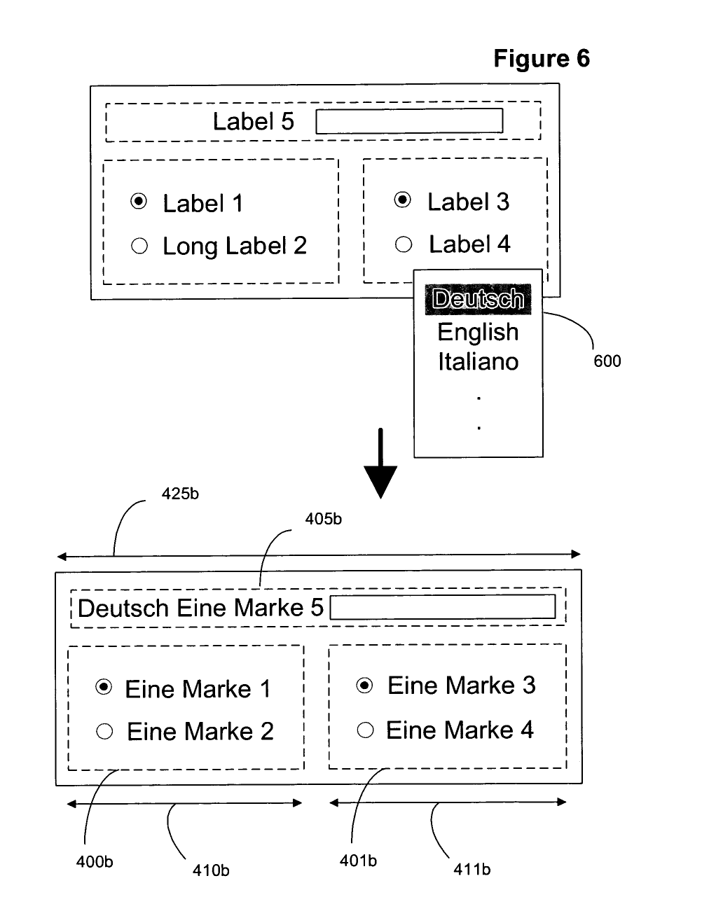

FIG. 6 shows popup menu 600 that is used to switch between displayed languages and the resulting window region (e.g., dialog box) having width 425b when displayed in a second language. When selecting a new language setting such as German, i.e., “Deutsch”, underlying text widths in the various components are calculated based on the text of the new language. For example, since “Eine Marke 3” is wider in the bottom dialog box than “Label 3” is in the upper dialog box, the width 411b is larger than the corresponding width 411a shown in FIG. 5. Since in this example the width of “Eine Marke 2” happens to be the exact same width as “Long Label 2” in the upper figure, width 410b is the same as width 410 in FIG. 5. Hence the overall width 425b of the dialog box increases. If “Deutsch Eine Marke 5” in the lower dialog box happens to be larger than the sum of the widths of groups 400b and 401b, e.g., the sum of widths 410b and 411b, then the width of “Deutsch Eine Marke 5” is used as width 425b.

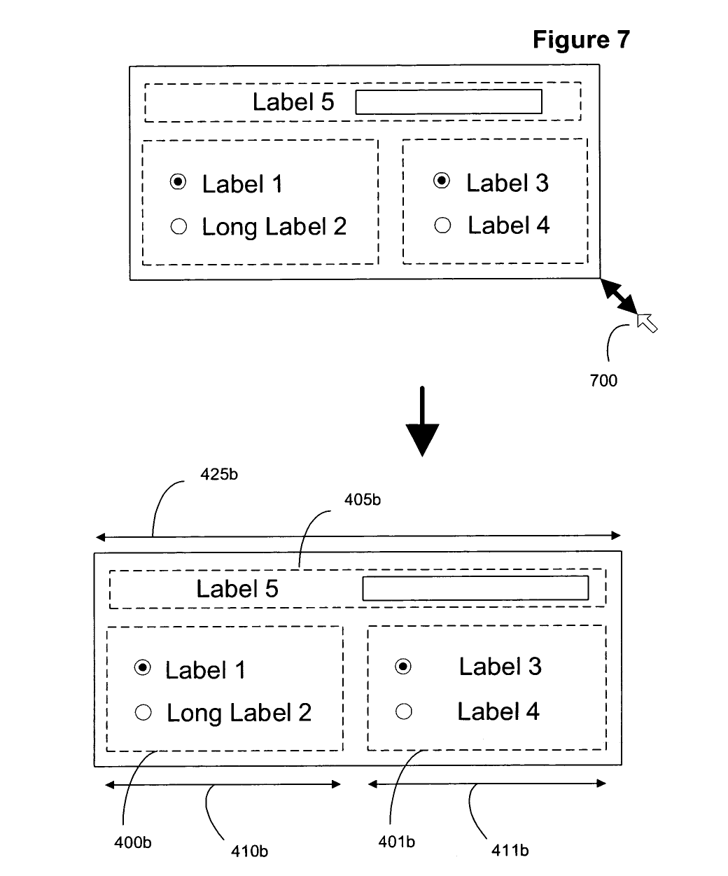

FIG. 7 shows a mouse-drag used to alter the size of the dialog for a given display language. Mouse 700 is dragged in any direction to resize the dialog box manually for a given language. When mouse 700 is released, the resulting dialog is shown at the bottom of the figure. The result is that the proportions of the dialogs remain the same or that the resulting groups size to the largest column in a row. In this example, the latter setting is used to maximize group 401b, e.g., width 411b with group 400b, e.g., width 410b. Any other method of introducing space between components for a given language is in keeping with the spirit of the invention. One or more embodiments of the invention disable the redrawing of the background of the dialog box or window region while dragging to prevent flicker.

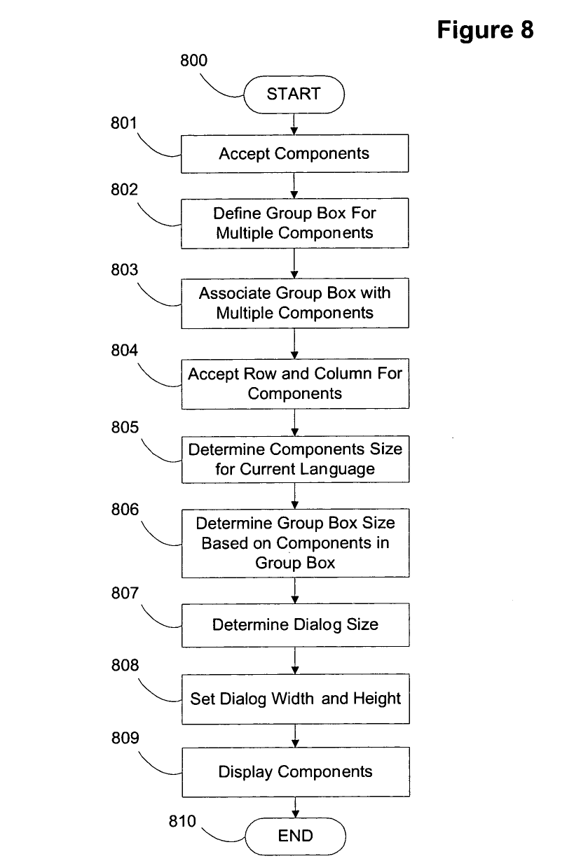

FIG. 8 shows an embodiment of a method for automatically adjusting the components of a dialog box to maintain layout integrity in multiple languages. Processing starts at 800 and the system accepts components from a creating user or from a programmatic generator of interfaces at 801. The system defines a group for multiple components when a user or program so commands at 802. The system associates components with the group at 803. The system accepts row and column settings for components at 804. The system determines the respective component sizes for a current display language at 805. The system determines the group size based on components in the group at 806. Optionally, if the setting SAME_WIDTH is applied to a list of cells, then the group size is set to the value of another group. Based on the components and groups in the window region, the various widths and heights are summed and the size of the window is determined by the system at 807. The system sets the dialog width and height at 808 and the system then displays the components at 809. Processing ends at 810.

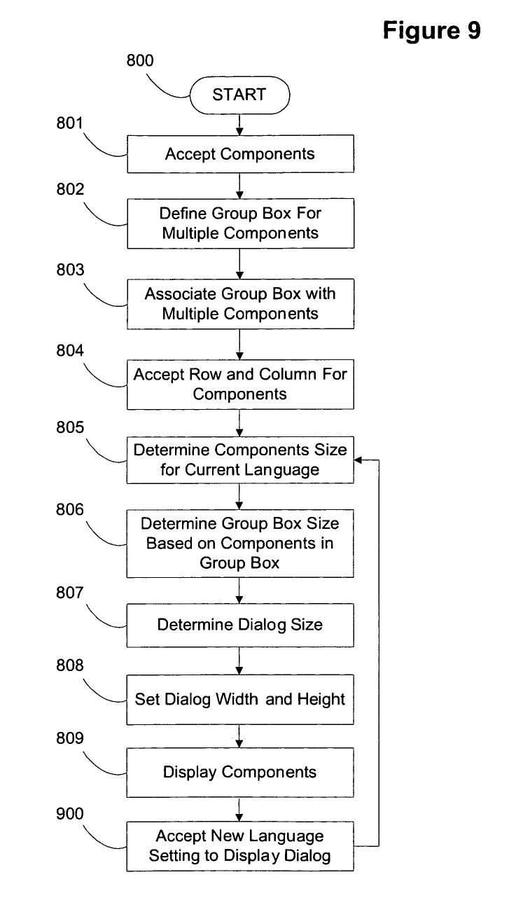

FIG. 9 shows a flowchart for an embodiment of the method for adjusting the components of a dialog box using a new language setting. Processing starts at 800 and the system accepts components from a creating user or from a programmatic generator of interfaces at 801. The system defines a group for multiple components when a user or program so commands at 802. The system associates components with the group at 803. The system accepts row and column settings for components at 804. The system determines the respective component sizes for a current display language at 805. The system determines the group size based on components in the group at 806. Optionally, if the setting SAME_WIDTH is applied to a list of cells, then the group size is set to the value of another group. Based on the components and groups in the dialog, the various widths and heights are summed and the size of the dialog box is determined by the system at 807. The system sets the dialog box width and height at 808 and the system then displays the components at 809. The system accepts a new language setting to display the dialog at 900. Processing returns to 805 where the component sizes are determined for the new language.

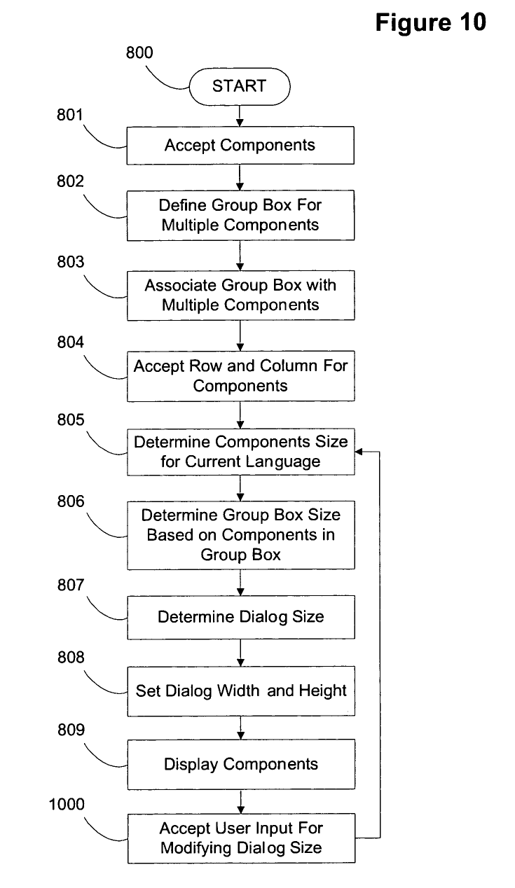

FIG. 10 shows a flowchart for an embodiment of the method for adjusting the components of a dialog box using a mouse-drag for a given language setting. Processing starts at 800 and the system accepts components from a creating user or from a programmatic generator of interfaces at 801. The system defines a group for multiple components when a user or program so commands at 802. The system associates components with the group at 803. The system accepts row and column settings for components at 804. The system determines the respective component sizes for a current display language at 805. The system determines the group size based on components in the group at 806. Optionally, if the setting SAME_WIDTH is applied to a list of cells, then the group size is set to the value of another group. Based on the components and groups in the dialog, the various widths and heights are summed and the size of the dialog is determined by the system at 807. The system sets the dialog width and height at 808 and the system then displays the components at 809. The system accepts a user input for modifying the dialog size at 1000. This may include a mouse drag or other keyboard input such as arrow keys or menu functions. Any other method of resizing the menu while utilizing a particular language setting (of which multiples may be chosen) is in keeping with the spirit of the invention. Processing returns to 805 where the component sizes are determined for the new language.

To avoid flicker, one or more embodiments disable automatic refresh for the windowing system while the dialog is dragged to a new size. The components and background are redrawn programmatically once instead of many times per second. This eliminates flicker on the screen. To accomplish resizing of screen regions, one or more embodiments of the invention saves the initial configuration parameters for use when switching languages or when the screen region is resized. During a callback involved with switching the language displayed in the dialog or when a dialog is resized by a user, the saved configuration parameters are utilized in resizing the dialog.

For some component types such as a text area, a calculation of the text width in the text area yields a large number that defines how long the text would be if displayed on one line. To avoid this type of sizing when calculating the widths of the various components, the text area is given a maximum displayable width and height size that allows for wrapping the text. Alternatively, the text area uses a setting that signifies the number of rows that is it to be displayed in. The text wrapping is accomplished via white space breaks before the maximum displayable width, or make use of hyphenation libraries that automatically hyphenate words using language dependent rules or tables. Alternatively, the user chooses to manually specify line breaks.

In the case of images, the images are specified to exist in a given column within a group and set to automatically scale up to fit the allotted row and column or alternatively set to remain a fixed size.

While the invention herein disclosed is described by means of specific embodiments and applications thereof, numerous modifications and variations could be made thereto by those skilled in the art without departing from the scope of the invention set forth in the claims.

What is claimed is:

1. A computer program product comprising computer readable instruction code executing in a tangible memory medium of a computer, said computer readable instruction code configured to:
determine a first component size for at least one graphical component based on a first language of a plurality of languages;
present said at least one graphical component in said first component size in a screen region of a graphical user interface;
determine a second component size for said at least one graphical component based on a second language of said plurality of languages; and
present said at least one graphical component in said second component size in said screen region of said graphical user interface.

2. The computer program product of claim 1 wherein said at least one graphical component comprises a plurality of graphical components associated with a first group and said first component size is calculated based on said plurality of components.

3. The computer program product of claim 2 wherein said plurality of graphical components each have associated cell designations used to constrain layout of said plurality of graphical components.

4. The computer program product of claim 3 wherein white space associated with said cell designation is determined by said at least one first component size.

5. A computer program product comprising:
computer readable instruction code for adjusting at least one component within a screen region of a graphical user interface to maintain layout integrity in a plurality of languages, said computer readable instruction code executing in a tangible memory medium configured to:
associate at least one component to be displayed in one of said plurality of languages within said screen region with layout information comprising column identification;
determine a longest length associated with said at least one component;
resize said screen region based on said longest length; and
display said at least one component in said one of said plurality of languages within said screen region in a position associated with said layout information.

6. The computer program product of claim 5 wherein said at least one component to be displayed within said screen region has said associated layout information comprising row position information.

7. The computer program product of claim 5 wherein said at least one component comprises a plurality of components and said layout information comprises a grouping of said plurality of components to be displayed within said screen region.

8. The computer program product of claim 5 wherein said at least one component comprises text and said computer readable program code is configured to:
define a maximum displayable width and height for a text area comprising text data;
calculate a text width to associate with said text data;
compare said maximum displayable width to said text width;
adjust said maximum displayable height to provide additional space in said text area for said text data;
insert a line break in said text at said maximum displayable width; and
display said text data in said text area.

9. A computer-readable storage medium comprising:
a set of instructions for a computer having a graphical user interface to execute, said computer configured to automatically adjust components of a dialog box within said graphical user interface to maintain layout integrity independent with multiple displayed languages by causing said set of instructions to:
identify a plurality of components to be displayed within said dialog box of said graphical user interface where said plurality of components comprises at least one first component and at least one second component;
obtain a first component size associated with said at least one first component where said first component size is based on a current language;
obtain a first component row and first component column associated with said at least one first component;
obtain a second component size associated with said at least one second component;
obtain a second component row and second component column associated with said at least one second component;
determine a grouping area size based on said first component size and said second component size;
determine a dialog box size for said dialog box based on said grouping area size;
display said at least one first component within said dialog box in said first component row and first component column; and
display said at least one second component within said dialog box in said second component row and second component column.

10. The computer readable storage medium of claim 9 wherein said size for said dialog box based on said grouping area size is defined by determining which of said first component size and said grouping area size is larger.

11. The computer readable storage medium of claim 10 wherein said set of instructions is further configured to set said dialog box size based on said first component size in cases where said first component size is larger than said grouping area size.

12. The computer readable storage medium of claim 10 wherein said set of instructions is further configured to set said dialog box size based on said group size if said group size is larger than said first component size.

13. The computer readable storage medium of claim 10 wherein said set of instructions is further configured to set a dialog width and height to said dialog box size.

14. The computer-readable storage medium of claim 9 wherein said set of instructions is further configured to accept a new current language setting and set said current language setting to said new current language setting.

15. The computer-readable storage medium of claim 9 wherein said set of instructions is further configured to redraw said dialog box once to avoid flicker.

16. The computer-readable storage medium of claim 9 wherein said set of instructions is further configured to distribute addition space between said first component row and said second component row.

17. The computer-readable storage medium of claim 9 wherein said set of instructions is configured to accept user input in modifying said dialog box width and said dialog box height and distribute extra space between and outside said set of components.
